(19) United States
(12) Patent Application Publication
(10) Pub. No.: US 2017/0311040 A1
(43) Pub. Date: Oct. 26, 2017

(54) SOCIAL NETWORK SCREENING FOR TIME-SHIFTED CONTENT VIEWING

(71) Applicant: Justin Barnes, Vista, CA (US)

(72) Inventor: Justin Barnes, Vista, CA (US)

(21) Appl. No.: 15/133,526

(22) Filed: Apr. 20, 2016

(51) Int. Cl. H04N 21/4788; H04N 21/61; H04N 21/462; H04N 21/262; H04N 21/433; H04N 21/432; H04N 21/414; H04N 21/41; H04N 21/845; H04N 21/4722

(52) U.S. Cl. CPC H04N 21/4788; H04N 21/8456; H04N 21/6175; H04N 21/6131; H04N 21/6125; H04N 21/4722; H04N 21/26283; H04N 21/4334; H04N 21/4325; H04N 21/41407; H04N 21/4126; H04N 21/4622

(57) ABSTRACT

An application is provided to a portable computing device to control access to social media. A user can play back recorded content that friends have commented on previously on social media. The user accesses the social media through the application, which limits presentation of comments to those made up to the current place in the content being played back but not after. This avoids spoiling the experience by avoiding the presentation of comments pertaining to parts of the content that have not yet been played back.

### FIELD

The application relates generally to screening social network information during time-shifted content viewing.

### BACKGROUND

People enjoy consulting their smart phones or tablet computers to view their friends' comments about broadcast events such as sporting events, or to otherwise access Internet sites ft information related to broadcast TV content. Owing to busy schedules, people also prefer to record some content so that it can be played back some time after the live (or first) broadcast.

### SUMMARY

As understood herein, when recorded content is played back and the viewer wants to access related Internet information such as social media to view their friends' related comments, the social media can potentially spoil the experience because social media can be expected to reflect comments made at a point in the original broadcast that the viewer has not yet reached during play back.

Accordingly, a device includes at least one computer memory that is not a transitory signal and that in turn includes instructions executable by at least one processor to access indication of play back of at least a first segment of recorded content that was broadcast, at broadcast time for recording. The time of play back of the first segment of recorded content is after the broadcast time that is associated with the first segment of recorded content. The first segment of recorded content is thus received for recording at the broadcast time associated with the first segment of recorded content. During play back of the first segment of recorded content, the instructions are executable to access at least one Internet site with information associated with the first segment of recorded content The instructions are executable to present first information from the Internet site responsive to a determination that the first information was made available on the Internet site no later than the broadcast time associated with the first segment of recorded content. The instructions are also executable block from presentation second information from the Internet site responsive to a determination that the second information was made available on the Internet site later than the broadcast time associated with the first segment of recorded content.

The computer memory may he implemented in a play back device on which the first segment of recorded content is played back. Or, the computer memory can be implemented in a consumer electronics (CE) device on which the first segment of recorded content is not played back. In this case, the CE device can be a wireless telephone and the first segment of recorded content can be Played hack on an audio video display device (AVDD) such as a TV that is different from the wireless telephone.

In example embodiments, the instructions can be executable to access metadata accompanying the first segment of recorded content to determine the broadcast time associated with the first segment of recorded content. In addition or alternatively, the instructions may be executable to receive the broadcast time associated with the first segment of recorded content from user input of the broadcast time. In addition or alternatively, the instructions may be executable to send at least one image in the first segment of recorded content to an Internet server, and responsive to sending the at least one image, receive back from the Internet server an indication of the broadcast time.

In another aspect, a method includes providing an application to a portable computing device to control access to social media, and accessing social media through the application. The application limits presentation of information on the social media to information pertaining to content being played back up to a currently presented location in the content being played back, but not after, to avoid spoiling a viewing experience by avoiding presentation of information pertaining to parts of the content that have not yet been played back.

In another aspect, a device includes at least one storage with instructions executable by at least one processor, at least one processor configured to access the storage, and at least one display configured to present information under control of the processor. The instructions are executable for presenting on the display at least one user interface (UI) that includes an enable selector and a disable selector. The enable selector is selectable to block, from presentation on the display, computer network information pertaining to content being played back responsive to a determination that the information pertains to at least one portion of the content awaiting play back. In contrast, the disable selector is selectable to allow computer network information pertaining to content being played back to be presented on the display regardless of whether the information pertains to at least one portion of the content awaiting play back.

The details of the present disclosure, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system including an example in accordance with present principles;

FIG. 2 is a flow chart of example logic; and

FIGS. 3-5 are screen shots of example user interfaces (UI).

### DETAILED DESCRIPTION

This disclosure relates generally to computer ecosystems including aspects of consumer electronics (CE) device based user information in computer ecosystems. A system herein may include server and client components, connected over a network such that data may be exchanged between the client and server components. The client components may include one or more computing devices including portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, operating systems from Microsoft, or a Unix operating system, or operating systems produced by Apple Computer or Google. These operating environments may be used to execute one or more browsing programs, such as a browser made by Microsoft or Google or Mozilla or other browser program that can access web applications hosted the Internet servers discussed below.

Servers may include one or more processors executing instructions that configure the servers to receive and transmit data over a network such as the Internet. Or, a client and server can be connected over a local intranet or a virtual private network. A server or controller may be instantiated by a game console, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

As used herein, instructions refer to computer-implemented steps for processing information in the system. Instructions can be implemented in software, firmware or harsh and include any type of programmed step undertaken by components of the system.

A processor may be any conventional general purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can he redistributed to other software modules and/or combined together in a single module and/or made available in a shareable library.

Present principles described herein can be implemented as hardware, software, firmware, or combinations thereof hence, illustrative components, blocks, modules, circuits, and steps are set forth in terms of their functionality.

Further to what has been alluded to above, logical blocks, modules, and circuits described below can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires.

Components included in one embodiment can he used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

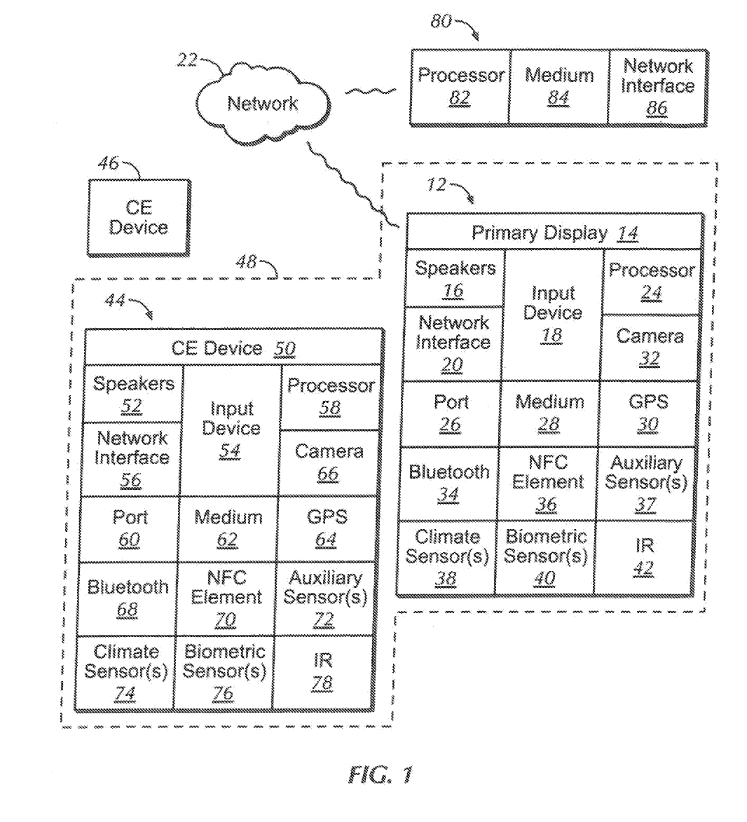

Now specifically referring to FIG. 1, an example ecosystem 10 is shown, which may include one or more of the example devices mentioned above and described further below in accordance with present principles. The first of the example devices included in the system 10 is an example primary display device, and in the embodiment shown is an audio video display device (AVDD) 12 such as but not limited to an Internet-enabled TV. Thus, the AVDD 12 alternatively may be an appliance or household item, e.g. computerized Internet enabled refrigerator, washer, or dryer. The AVDD 12 alternatively may also be a computerized Internet enabled (“smart”) telephone, a tablet computer, a notebook computer, a wearable computerized device such as e.g. computerized Internet-enabled watch, a computerized Internet-enabled bracelet, other computerized Internet-enabled devices, a computerized Internet-enabled music player, computerized. Internet-enabled head phones, a computerized Internet-enabled implantable device such as an implantable skin device, etc. Regardless, it is to be understood that the AVDD 12 is configured to undertake present principles (e.g. communicate with other CF devices to undertake present principles, execute the logic described herein, and perform any other functions and/or operations described herein).

Accordingly, to undertake such principles the AVDD 12 can he established by some or all of the components shown in FIG. 1. For example, the AVDD 12 can include one or more displays 14 that may he implemented by a high definition or ultra-high definition “4K” or “8K” for higher resolution) flat screen and that may be touch-enabled for receiving consumer input signals via touches on the display. The AVDD 12 may include one or more speakers 16 for outputting audio in accordance with present principles, and at least one additional input device 18 such as e.g. an audio receiver/microphone for e.g. entering audible commands to the AVDD 12 to control the AVDD 12. The example AVDD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface. It is to be understood that the processor 24 controls the AVDD 12 to undertake present principles, including the other elements of the AVDD 12 described herein such as e.g. controlling the display 14 to present images thereon and receiving input therefrom. Furthermore, note the network interface 20 max be, e.g., a wired or wireless modem or router, or other appropriate interface such as, e.g., a wireless telephony transceiver, or Wi-Fi transceiver as mentioned above, etc.

In addition to the foregoing, the AVDD 12 may also include one or more input ports 26 such as, e.g., a USB port to physically connect (e.g. using a wired connection) to another CE device and/or a headphone port to connect headphones to the AVDD 12 for presentation of audio from the AVDD 12 to a consumer through the headphones. The AVDD 12 may further include one or more computer memories 28 that are not transitory signals, such as disk-based or solid state storage (including but not limited to flash memory). Also in some embodiments, the AVDD 12 can include a position or location receiver such as but hot limited to a cellphone receiver, GPS receiver and/or altimeter 30 that is configured to e.g. receive geographic position information from at least one satellite or cellphone tower and provide the information to the processor 24 and/or determine an altitude at which the AVDD 12 is disposed in conjunction with the processor 24. However, it is to be understood that that another suitable position receiver other than a cellphone receiver, GPS receiver and/or altimeter may be used in accordance with present principles to e.g. determine the location of the AVDD 12 in e.g. all three dimensions.

Continuing the description of the AVDD 12, in some embodiments the AVDD 12 may include one or more cameras 32 that may be, e.g., a thermal imaging camera, a digital camera such as a webcam, and/or a camera integrated into the AVDD 12 and controllable by the processor 24 to gather pictures images and/or video in accordance with present principles. Also included on the AVDD 12 may be a Bluetooth transceiver 34 and other Near Field Communication (NFC) element 36 for communication with other devices using Bluetooth and/or NFC technology, respectively. An example NFC element can be a radio frequency identification (RPM) element.

Further still, the AVDD 12 may include one or more auxiliary sensors 37 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the processor 24. The AVDD 12 may include still other sensors such as e.g. one or more climate sensors 38 (e.g. barometers, humidity sensors, wind sensors, light sensors, temperature sensors, etc.) and/or one or more biometric sensors 40 providing input to the processor 24. In addition to the foregoing, it is noted that the AVDD 12 may also include an infrared (IR) transmitter and/or IR receiver and/or IR transceiver 42 such as an IR data association (IRDA) device. A battery (not shown) may be provided for powering the AVDD 12.

Still referring to FIG. 1, in addition to the AVDD 12, the system 10 may include one or more other CE device types. In one example, a first CE device 44 and a second CE device 46, which may include similar components as the first CE device 44 and hence will not be discussed in detail, may be operatively coupled to the AVDD 12. In the example shown, only two CE devices 44, 46 are shown, it being understood that fewer or greater devices may be used.

In the example shown, to illustrate present principles all three devices 12, 44, 46 are assumed to be members of an entertainment network, in, e.g., in a home, or at least to be present in proximity to each other in a location such as a house. However, for illustrating present principles the first CE device 44 is assumed to be in the same room as the AVDD 12, bounded by walls illustrated by dashed lines 48.

The example non-limiting first CE device 44 may be established by any one of the above-mentioned devices, for example, a wireless smart phone, a portable wireless laptop computer or notebook computer, and accordingly may have one or more of the components described below.

The first CE device 44 may include one or more displays 50 that may be touch-enabled for receiving consumer input signals via touches on the display. The first CE device 44 may include one or in more speakers 52 for outputting audio in accordance with present principles, and at least one additional input device 54 such as e.g. an audio receiver/microphone for e.g. entering audible commands to the first CE device 44 to control the device 44. The example first CE device 44 may also include one or more network interfaces 56 for communication over the network 22 under control of one or more CE device processors 58. Thus, the interface 56 may be, without limitation, a Wi-Fi transceiver, which is au example of a wireless computer network interface. It is to be understood that the processor 58 controls the first CE device 44 to undertake present principles, including the other elements of the first CE device 44 described herein such as e.g. controlling the display 50 to present images thereon and receiving input therefrom. Furthermore, note the network interface 56 may be, e.g., a wired or wireless modem or router, or other appropriate interface such as, e.g., a wireless telephony transceiver, or Wi-Fi transceiver as mentioned above etc.

In addition to the foregoing, the first CE device 44 may also include one or more input ports 60 such as, e.g., a USB port to physically connect (e.g. using a wired connection) to another CE device and/or a headphone port to connect headphones to the first CE device 44 for presentation of audio from the first CE device 44 to a consumer through the headphones. The first CE device 44 may further include one or more computer memories 62 such as disk based or solid state storage. Also in some embodiments, the first CE device 44 can include a position or location receiver such as but not limited to a cellphone and/or GPS receiver and/or altimeter 64 that is configured to e.g. receive geographic position information from at least one satellite and/or cell tower, using triangulation, and provide the information to the CE device processor 58 and/or determine an altitude at which the first CE device 44 is disposed in conjunction with the CE device processor 58. However, it is to be understood that that another suitable position receiver other than a cellphone and/or GPS receiver and/or altimeter may be used in accordance with present principles to e.g. determine the location of the first CE device 44 in e.g. all three dimensions.

Continuing the description of the first CE device 44, in some embodiments the first CE device 44 may include one or inure cameras 66 that may be, e.g., a thermal imaging camera, a digital camera such as a webcam, and/or a camera integrated into the first CE device 44 and controllable by the CE device processor 58 to gather pictures/images and/or video in accordance with present principles. Also included on the first CE device 44 may be a Bluetooth transceiver 68 and other Near Field Communication (NFC) element 70 for communication with other devices using Bluetooth and/or NEC technology, respectively. An example NFC element can be a radio frequency identification (RFID) element.

Further still, the first CE device 44 may include one or more auxiliary sensors 72 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the CE device processor 58. The first CE device 44 may include still other sensors such as e.g. one or more climate sensors 74 (e.g. barometers, humidity sensors, wind sensors, light sensors, temperature sensors, etc.) and/or one or more biometric sensors 76 providing input to the CE device processor 58. In addition to the foregoing, it is noted that in some embodiments the first CE device 44 may also include an infrared (IR) transmitter and/or IR receiver and/or IR transceiver 78 such as an IR data association (IRDA) device. A battery (not shown) may be provided for powering the first device 44.

The second CE device 46 may include some or all of the components shown for the CE device 44.

Now in reference to the afore-mentioned at least one server 80, it includes at least one server processor 82, at least one computer memory 84 such as disk-based or solid state storage, and at least one network interface 86 that, under control of the server processor 82, allows for communication with the other devices of FIG. 1 over the network 22, and indeed may facilitate communication between servers and client devices in accordance with present principles. Note that the network interface 86 may be, e.g., a wired or wireless modem or router, Wi-Fi transceiver, or other appropriate interface such as, e.g., a wireless telephony transceiver.

Accordingly, in some embodiments the server 80 may be an Internet server, and may include and perform “cloud” functions such that the devices of the system 10 may access a “cloud” environment via the server 80 in example embodiments. Or, the server 80 may be implemented by a game console or other computer in the same room as the other devices shown in FIG. 1 or nearby.

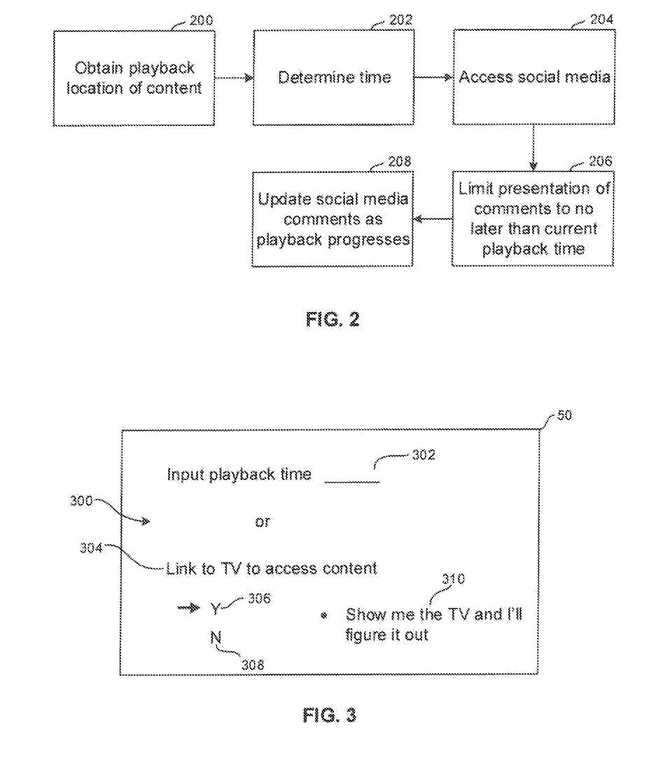

FIG. 2 shows example logic that may he implemented according to present principles. In the example shown, the logic may be executed by the first CE device 44 implemented as a wireless telephone or tablet computer or other portable computer or personal computer. In embodiments in which the AVDD primary display is large enough to present both the content for play hack and an Internet window presenting social media feeds, the logic may be implemented by the AVDD 12 itself.

Typically, the logic herein may be downloaded from the cloud (e.g., from the server 80) as an application or “app” to the CE device 44 and/or AVDD 12.

Commencing at block 200, it is assumed that the user has decided to play hack previously recorded content that was broadcast at an earlier time. At block 200 the location in the content (such as the frame) currently being played back is obtained, and the associated time of day at which the content was received from the broadcast for recording (essentially, the time in the past that the content was broadcast from a content source such as a satellite or cable head end) is determined at block 202. These steps may include accessing metadata accompanying the content for the original broadcast time. Or, during play back a user can enter the play back time as described further below.

When the logic is executed by the AVDD 12 in a self-contained manner, the executing processor can simply access the content and its related metadata directly from local storage to make the determinations at blocks 200 and 202.

On the other hand, when the logic is executed by the CE device 44, the CE device 44 may communicate, using Bluetooth or Wi-Fi or other communication link, with the AVDD 12 on which the content is being played back to query the AVDD 12 for the play back location and associated metadata, including time. The AVDD 12 can regularly send update messages to the CE device 44 as to play back status, including trick play commands causing play back to pause or jump to another part of the content, so that the CE device 44 remains apprised of what part of the content is currently being played back and, hence, the time the currently played back content was received for recording (essentially, when it was broadcast).

Yet again, when the logic is executed by the CE device 44, the camera of the CE device 44 may be used to image the display of the AVDD 12, with object recognition executed on a still or video image thereby obtained and used as entering argument to a database of content to identify the content and the location in the content currently being viewed. Once the location is known, the time at which the content at the currently played back location was broadcast may be obtained from the same or different database containing scheduling of previously broadcast content. If desired, the image of the AVDD display taken by the camera of the CE device 44 may be uploaded to a cloud server for object recognition and content classification using a cloud database, in lieu of importing the database to the CE device 44 and requiring the CE device 44 to execute the described operations.

Once the executing processor or processors has obtained the tune of recording (equivalently, broadcast time) of the part (such as the frame) of the content currently being played back on the AVDD 12, one or more social networks may be accessed at block 204. This may be facilitated during setup using a series of screen shots through which the user can enter any log on credentials needed such as user name and password for the user's social networks. These credentials may be retrieved and used at block 204 to automatically access one or more of the user's various social network accounts.

Information from the user's accounts on the one or more social networks, such as the comments of social network friends of the user, may then be presented either on the AVDD 12 (e.g., in split screen mode) and/or on the CE device 44 at block 206, with the following proviso. Presentation is limited, at least with respect to information that is relevant to the content being played back on the AVDD 12, to information that was posted on the social network no later than the broadcast time of the part of the content currently being played back.

In executing block 206, one or more methods may be implemented. For feeds that are in the form of time lines, the logic may simply use character recognition of the times on the time lines to determine which information was posted according to the time line on or before the broadcast time of the content portion currently being played back. Any information posted after the broadcast time of the portion of content currently being played back is screened from being presented. Such information may be stored internally for later presentation as the play back progresses.

In addition or alternatively, metadata in the social network site may be accessed to determine posting times for information presented on the social network site. Yet again, the Internet site being accessed may be queried, e.g., using the title of the content currently being played back, for information related to the content, with the query specifying information originally generated or posted no later than the broadcast time of the content portion currently being played hack on the AVDD 12. Thus, for example, a sport network Internet site may he queried for a baseball lineup as of the broadcast time of the content portion currently being played back, so that the final score of the game, as an example, would not be presented on the CE device 44 or AVDD 12.

As play heck progresses on the AVDD 12, the logic may periodically or continually update the Internet information such as social network comments presented on the AVDD 12/CE device 44 at block 208 by periodically or continually updating the broadcast time associated with the recorded content portion currently being played back.

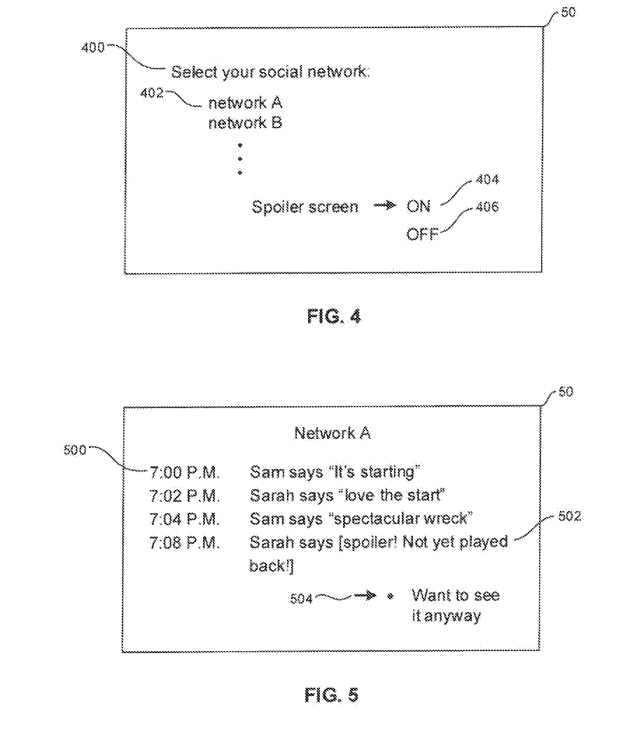

FIG. 3 shows a user interface (UI) 300 including a field 302 into which a user can directly input the time associated with content being played back on the AVDD 12. In the example shown, the UI is presented on the display 50 of the CE device 44, it being understood that the UIs herein may alternatively or additionally be presented on the AVDD itself.

The time input in the field 302 may be read by the user from metadata that may be presented in concert with the content during play back. The user views the metadata on the AVDD screen and inputs it into the field 302.

In addition or alternatively, a prompt 304 may he presented to establish a link between the CE device 44 and AVDD 12, such as a Bluetooth link, to enable the CE device 44 to access information from the AVDD 12 including the time of recordation associated with the content portion currently being played back. If the user desires this mode he may select a “yes” selector 306; otherwise, a “no” selector 308 may be provided.

Yet again, as mentioned above object recognition may be employed to determine when the content portion currently being played back was broadcast, and in this embodiment a selector 310 may be presented prompting the user to take a photo or short video of the content being presented on the AVDD 11, for analysis described previously.

FIG. 4 illustrates a UI promoting, at 400, the user to select one or more social networks from a list 402, which may be generated using the setup credential provisioning described previously. As contemplated in the example shown in FIG. 4, it may be desirable to allow the user to enable and disable the spoiler screening logic of FIG. 2 for certain recorded content during playback, and so an enable selector 404 may he provided which when selected enable the logic of FIG. 2. A disable selector 406 may be presented which when selected disables the logic of FIG. 2, permitting comments and other information from social networks to be presented even if the comments were posted after the broadcast time of the content portion currently being played back.

FIG. 5 illustrates a UI of social network comments arranged in a time line 500. In the example shown, it is assumed that the recorded content currently being presented on the AVDD 12 was originally broadcast or recorded after 7:04 P.M. and prior to 7:08 P.M. Accordingly, the last comment (albeit not potentially the name of the person making a subsequent comment) presented is no later than 7:04 P.M. as shown, with a message 502 indicating that a later comment may be a spoiler as pertaining to a portion of recorded content that has not yet been played back. A spoiler selector 504 may be presented that the user can select to view later comments regardless, at the risk of spoiling the experience.

While the particular technology is herein shown and described in detail, it is to be understood that the subject matter which is encompassed by the present invention is limited only by the claims.

What is claimed is:

1. A device comprising:
at least one computer memory that is not a transitory signal and that comprises instructions executable by at least one processor to:
access indication of play back of at least a first segment of recorded content that was broadcast at broadcast time for recording, a time of play back of the first segment of recorded content being after the broadcast time associated with the first segment of recorded content, the first segment of recorded content being received for recording at the broadcast time associated with the first segment of recorded content;
during play back of the first segment of recorded content, access at least one Internet site with information associated with the first segment of recorded content;
present first information from the Internet site responsive to a determination that the first information was made available on the Internet site no later than the broadcast time associated with the first segment of recorded content; and
block from presentation second information from the Internet site responsive to a determination that the second information was made available on the Internet site later than the broadcast time associated with the first segment of recorded content.

2. The device of claim 1, further comprising the at least one processor.

3. The device of claim 1, further comprising at least one display device on which the first segment of recorded content is played back.

4. The device of claim 1, wherein the computer memory is implemented in a play back device on which the first segment of recorded content is played back.

5. The device of claim 1, wherein the computer memory is implemented in a consumer electronics (CE) device on which the first segment of recorded content is not played back.

6. The device of claim 5, wherein the CE device is a wireless telephone and the first segment of recorded content is played back or an audio video display device (AVDD) different from the wireless telephone.

7. The device of claim 1, wherein the instructions are executable to:
access metadata accompanying the first segment of recorded content to determine the broadcast time associated with the first segment of recorded content.

8. The device of claim 1, wherein the instructions are executable to:
receive the broadcast time associated with the first segment of recorded content from user input of the broadcast time.

9. The device of claim 1, wherein the instructions are executable to:
send at least one image in the first segment of recorded content to an Internet server; and
responsive to sending the at least one image, receive back from the Internet server an indication of the broadcast time.

10. A method comprising:
providing an application to a portable computing device to control access to social media;
accessing social media through the application:
the application limiting presentation of information on the social media to information pertaining to content played back up to a currently presented location in the content being played back, but not after to avoid spoiling a viewing experience by avoiding presentation of information pertaining to parts of the content that have not yet been played back.

11. The method of claim 10, comprising:
accessing metadata accompanying the content to determine a broadcast time associated with the content.

12. The method of claim 10, comprising:
receiving a broadcast time associated with the from user input of the broadcast time.

13. The method of claim 10, comprising:
sending at least one image in the content to an Internet server; and
responsive to sending the at least one image, receiving back from the Internet solver an indication of a broadcast time of the content.

14. A device comprising:
at least one storage with instructions executable by at least one processor;
at Last one processor configured to access the storage; and
at least one display configured to present information under control of the processor, wherein the instructions are executable for:
presenting on the display at least one user interface (UI) comprising an enable selector and a disable selector,
the enable selector being selectable to block, from presentation on the display, computer network information pertaining to content being played back responsive to a determination, that the information pertains to at least one portion of the content awaiting play back,
the disable selector being selectable to allow computer network information pertaining to content being played back to he presented on the display regardless of whether the information pertains to at least one portion of the content awaiting play back.

15. The device of claim 14, wherein the instructions are executable to:
receive selection of the enable selector;
access a source of the computer network information;
responsive to selection of the enable selector, limit presentation of information from the source to information pertaining to content being played back up to a currently presented location in the content being played back, but not after, avoiding presentation of information pertaining to parts of the content that have not yet been played back.

16. The device of claim 15, wherein the instructions are executable to:
access metadata accompanying the content to determine a broadcast time associated with the content.

17. The device of claim 15, wherein the instructions are executable to:
receive a broadcast time associated with the from user input of the broadcast time.

18. The device of claim 15, wherein the instructions are executable to:
send at least one image in the content to an Internet server; and
responsive to sending the at least one image, receive back from the Internet server an indication of a broadcast time of the content.
